(19) United States
(12) Patent Application Publication
(10) Pub. No.: US 2026/0352682 A1
(43) Pub. Date: Nov. 5, 2026

(54) OUTBOUND CONTENT SHARING PROTECTION

(71) Applicant: Abnormal AI, Inc., Las Vegas, NV (US)

(72) Inventors: Sanjay Jeyakumar, El Cerrito, CA (US); Abhijit Bagri, Atlanta, GA (US); Mickey Dang, New York City, NY (US)

(21) Appl. No.: 19/195,270

(22) Filed: Apr. 30, 2025

(51) Int. Cl. H04L 9/40

(52) U.S. Cl. CPC H04L 63/1425; H04L 63/102; H04L 63/1416

(57) ABSTRACT

A security profile for a user is tracked based at least in part on content interaction history of the user. An indication that the user is requesting to share content is received. Context of the requested sharing is analyzed based at least in part on the security profile to determine a security risk associated with the requested sharing. A security action is performed based on the determined security risk.

### BACKGROUND OF THE INVENTION

Cloud-based applications enable rapid collaboration, document sharing, and communication both within and outside organizational boundaries. However, by removing many of the technical challenges involved in collaboration and sharing, they also present significant challenges for data security, particularly in preventing the unauthorized or inadvertent dissemination of sensitive information. Traditional data loss prevention (DLP) systems rely heavily on manually created rules or policies. These systems are typically configured to inspect outbound content, including email subject lines, attachments, and body text, for specific keywords, regular expressions, or predefined patterns. In many cases, they also require explicit labeling of documents or content to trigger protective actions.

While effective in narrow scenarios, rule-based approaches lack the flexibility and context-awareness necessary for handling the dynamic and complex nature of modern business communications. Moreover, manually authored rules can be difficult to maintain and are often prone to false positives and negatives. Increasingly, organizations struggle to scale their DLP programs, placing additional burdens on security teams and requiring more excessive end-user intervention. As a result, many sensitive documents and data sets remain unprotected or are improperly classified, leaving companies vulnerable to both accidental and malicious data leaks. Therefore, there is a need for a more adaptive, intelligent, and scalable approach to outbound data loss prevention that does not rely on rigid rule sets but rather can adapt to organizational behavior and can assess risk based on context rather than just content.

### BRIEF DESCRIPTION OF THE DRAWINGS

Various embodiments of the invention are disclosed in the following detailed description and the accompanying drawings.

FIG. 1 is a block diagram illustrating an embodiment of a system for providing outbound content sharing protection.

FIG. 2 is a block diagram illustrating an embodiment of a content sharing protection service.

FIG. 3 is a flow chart illustrating an embodiment of a process for protecting against data loss from content sharing.

FIG. 4 is a flow chart illustrating an embodiment of a process for monitoring and tracking content sharing behavior.

FIG. 5 is a flow chart illustrating an embodiment of a process for identifying a security risk associated with a request to share content.

FIG. 6 is a flow chart illustrating an embodiment of a process for identifying a security risk based on the behavioral context of a content sharing request.

FIG. 7 is a flow chart illustrating an embodiment of a process for remediating an identified security risk associated with a request to share content.

FIG. 8 is a functional diagram illustrating a programmed computer system for providing outbound content sharing protection.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Outbound content sharing protection is disclosed. Using the disclosed techniques and systems, sensitive content including documents and data sets can be secured and protected against malicious as well as accidental data loss. The disclosed approaches can be applied for different domains such as for services supporting email (including outbound email), content-sharing websites, and/or video conference and other shared communication channels, among other service platforms including management service platforms. Unlike traditional rules-based approaches, the disclosed outbound content sharing protection is an automated, behavior-based solution that leverages multiple different profiles including user-specific communication patterns and document sharing histories, among other contextual behavioral inputs. Insights gathered by monitoring user, content, and/or vendor behavior is used to automatically identify anomalous and/or unintended sharing of content. For example, a financial document with identified confidential human resources data can be commonly shared between a select group of finance department members. When an attempt is made to share the same human resources document with a representative of an outside third-party equipment vendor, the share request is identified as anomalous and a potential security risk. The share request may be intentional or inadvertent, such as in the event the representative of the outside vendor has the same name as one of the trusted members of the finance department. Based on the anomalous behavior, the share request is identified as a security risk, and a security action can be performed to prevent potential data loss.

In various embodiments, the disclosed inventions utilize behavioral profiles to predict and prevent potential data loss events, including both accidental and deliberate exfiltration, without the hardware and performance scaling limitations and the intensive administration overhead of traditional data loss prevention techniques. As disclosed, the inventions enable real-time enforcement by performing security actions such as warning notifications, blocking, and/or security risk auditing, thereby significantly improving security while minimizing operational friction for end users and security administrators. For example, an outbound email with confidential content, such as confidential content in the email body, an attachment, or an embedded link, can be automatically identified as a security risk, blocked from being sent, and quarantined. In various embodiments, the identified security risks are automatically resolved and/or a reporting interface offers the ability to quickly and easily initiate manual or on-demand resolutions, such as releasing an email from quarantine. Moreover, the disclosed inventions include a pathway for training users to identify and prevent future security risks. For example, as part of a security risk notification process, a user can be presented with a training session to explain how to identify and prevent future incidents of a similar nature.

In some embodiments, a security profile for a user based at least in part on content interaction history of the user is tracked. For example, profiles for users can be tracked including the group of users with which each user commonly communicates. Additional context such as the mode, frequency, timing, length, style, and/or tone, among other behavioral properties of the communication can also be tracked as part of a behavioral-based security profile. In various embodiments, other behavioral-based security profiles are tracked, such as content and vendor profiles, among others. For example, tracked content profiles can include tracked context on how a document is used, how a document is accessed, how a document is shared, commonly used words or tone used by a confidential or sensitive document, etc. As another example, tracked vendor profiles can include tracked context on interaction, relationship, and history data for particular vendors such as service vendors. Service vendors can include cloud-based management services, such as human resources, sales, and project management services as well as financial services. In some embodiments, an indication that the user is requesting to share content is received. For example, a request to share content, such as an outbound email or a shared link in a message, is detected. In some embodiments, shared requests can be detected by integrating with third-party cloud services. In addition to outbound email, share requests can involve links, documents, or attachments shared in messaging services, file sharing services, and/or communication services such as video conferencing channels, among others.

In some embodiments, context of the requested sharing is analyzed based at least in part on the security profile to determine a security risk associated with the requested sharing. For example, once an indication of a share request is detected, the request is analyzed to predict the likelihood that the request is a security risk. The prediction performed is based on one or more tracked behavioral-based security profiles, such as the users, content, and/or vendors implicated by the share request. In various embodiments, the prediction is performed using a large language model (LLM), such as by providing an LLM service with the tracked behavioral-based security profiles and the context of the requested content share.

In some embodiments, a security action based on the determined security risk is performed. For example, security actions including presenting a warning related to the outbound share, blocking the outbound share, and/or auditing the content share can be performed. Additionally, a training session can be initiated to teach the user how to prevent the inadvertent sharing of content. The training session can be a conversational session implemented via a chat session using an AI agent. In some embodiments, when the security risk is identified as malicious, such as in the case of intellectual property theft, the determined security risk is elevated and additional precautions can be taken, such as disabling a user account and immediately notifying security administrators.

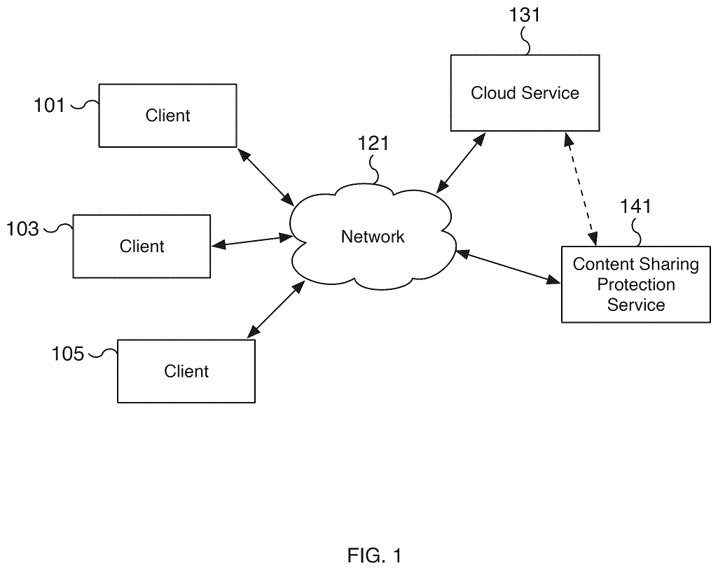

FIG. 1 is a block diagram illustrating an embodiment of a system for providing outbound content sharing protection. In the example shown, cloud services are provided by cloud service 131 to clients such as clients 101, 103, and 105. Content sharing requests initiated for content associated with cloud service 131 are monitored by content sharing protection service 141 to protect against unauthorized or inadvertent dissemination. Clients 101, 103, and 105 are communicatively connected to cloud service 131 and content sharing protection service 141 via network 121. Similarly, cloud service 131 and content sharing protection service 141 are communicatively connected to one another via network 121. Network 121 can be a public or private network. In some embodiments, network 121 is a public network such as the Internet. Using the disclosed techniques and systems, content sharing requests can be detected and analyzed to prevent data loss. When a content sharing request is found by content sharing protection service 141 to be a security risk, such as an outbound email that includes confidential content to an unauthorized recipient, the security risk can be addressed by performing one or more security actions. The security action can include blocking, warning, auditing, and/or training, among other security actions. Although the outbound content sharing protection solution of FIG. 1 may at times be described with respect to outbound email messages, the solution is applicable for other domains such as file sharing, conferencing, messaging, and/or other services that allow for content sharing.

In some embodiments, clients 101, 103, and 105 are each a network client device for interfacing with cloud service 131 and/or content sharing protection service 141. For example, clients 101, 103, and/or 105 can correspond to users of an organization configured to access a messaging service such as an email service offered by cloud service 131. As another example, clients 101, 103, and/or 105 can correspond to information security personnel or other users with authorized security credentials that utilize content sharing protection service 141 for performing security responsibilities, including managing content sharing protection and/or remediating detected security risks related to shared content. In some embodiments, the remediation actions can include follow-up training on a detected security risk.

In some embodiments, cloud service 131 is a cloud-based platform for providing cloud services that include sharing functionality such as email, file sharing, conferencing, messaging, and/or data management, among other services that allow for content sharing. For example, cloud service 131 may offer the ability to send outbound email that either includes confidential content within an email body, an attachment that includes confidential content, and/or a link that grants access to confidential content, among other techniques for embedding confidential content within an outbound email. In various embodiments, when an action initiates the sharing of content, such as an outbound email, a content sharing request or an indication to share content is triggered and detected by content sharing protection service 141.

In some embodiments, content sharing protection service 141 monitors content sharing associated with services such as cloud service 131 and prevents unauthorized or inadvertent data loss. For example, content sharing protection service 141 is integrated to access cloud service 131, such as via integration application programming interfaces. In various embodiments, content sharing protection service 141 monitors cloud service 131 and tracks various behavioral-based security profiles, such as user, content, and/or vendor behavioral profiles. For example, a user security profile created based on cloud service 131 can track the interaction history of each user account of cloud service 131, such as the context within which each user communicates with other users. Similarly, a content security profile created based on cloud service 131 can track the context of content, such as documents, links, conference lines, etc., that are managed by cloud service 131. For example, certain documents may be financial documents, product planning documents, legal documents, or another category of documents. As another example, documents with certain keywords or that use a particular tone may be considered confidential documents or have a heightened level of security. In some embodiments, a vendor security profile can be created to track the usage context for each cloud service vendor. Using one or more behavioral-based security profiles, a content sharing request can be analyzed to determine whether the underlying behavior of the request is anomalous and a potential security risk. In various embodiments, a security action is automatically performed in response to a detected security risk, such as to block the request and/or initiate a warning that a security risk is associated with the request. In some embodiments, the content sharing request can be audited and/or a training session can be initiated to teach the user how to avoid similar security risk events. In various embodiments, a reporting process allows users to access, manage, and/or view detected risks and/or to manually resolve risks. For example, a blocked outbound email can be released from quarantine and sent to the original recipient. As another example, a blocked outbound email can be modified to remove the detected security risk before it is sent. In some embodiments, the behavioral-based security profiles are created when the targeted data and corresponding relationships are in an at-rest state. The profiles are then applied, including by using a large language model (LLM) to predict security risks and associated risk scores, when content sharing data is in an in-flight state, such as when content sharing requests are initiated.

Although single instances of some components have been shown to simplify the diagram of FIG. 1, additional instances of any of the components shown in FIG. 1 may exist. For example, cloud service 131 may be implemented by one or more cloud service provider servers and content sharing protection service 141 may be implemented by one or more content sharing protection servers. In some embodiments, some of the servers and their functionalities may be merged. Additionally, clients 101, 103, and 105 are example client devices. Although three clients are shown (clients 101, 103, and 105), many more additional clients can exist. Similarly, although only a single cloud service is shown (cloud service 131), many more cloud services including file sharing, conferencing, and/or other services that support content sharing can be supported and monitored for data loss protection by content sharing protection service 141. In some embodiments, components not shown in FIG. 1 may also exist and/or the network configuration of the included components may differ from what is shown.

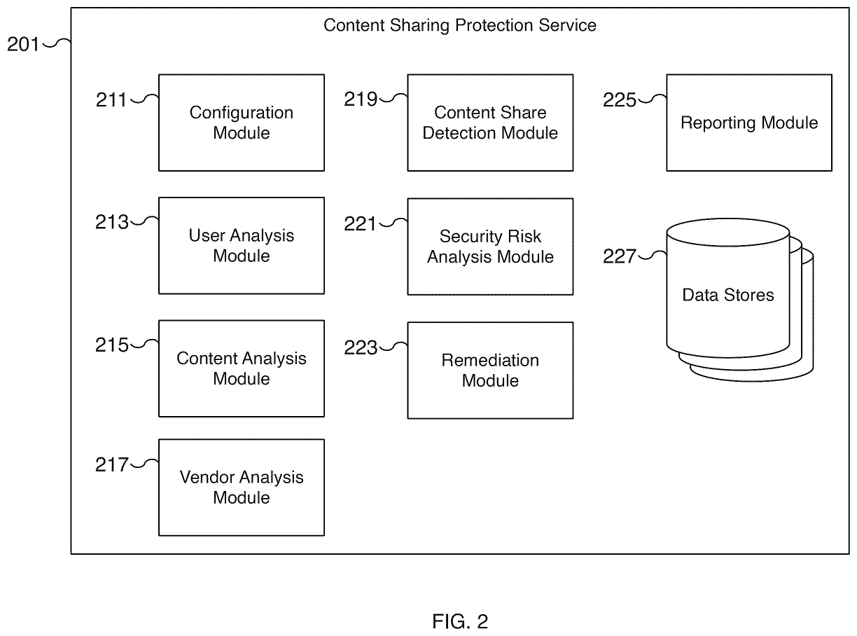

FIG. 2 is a block diagram illustrating an embodiment of a content sharing protection service. In the example shown, content sharing protection service 201 includes configuration module 211, user analysis module 213, content analysis module 215, vendor analysis module 217, content share detection module 219, security risk analysis module 221, remediation module 223, reporting module 225, and data stores 227. Using content sharing protection service 201, content sharing requests associated with one or more cloud services can be analyzed to prevent unauthorized or inadvertent data loss. In some embodiments, content sharing protection service 201 is content sharing protection service 141 of FIG. 1 and at least one of the cloud services monitored by content sharing protection service 201 can include cloud service 131 of FIG. 1.

In some embodiments, configuration module 211 is a processing module for configuring a content sharing protection service including for configuring the integration with different cloud services and preferences for remediation security actions. For example, configuration module 211 can process configuration parameters provided by security personnel for configuring interoperation with service providers such as third-party vendors including cloud-based email services. In some embodiments, security actions such as whether to warn or block a content share request associated with a security risk can also be configured. In some embodiments, configuration module 211 is further used to configure localized preferences for identifying content that should not be shared. For example, keywords such as project code names or other indicators of sensitive content can be configured and used to help identify interactions with sensitive content. In various embodiments, the configuration parameters are received via a web interface such as a web application or web service.

In some embodiments, user analysis module 213 is a behavioral-based analysis module for generating, monitoring, and tracking a behavioral-based user security profile. The tracked profile data can be based on the interaction history of tracked users including the context of user interactions. For example, a tracked profile can track the users with which each user commonly communicates. Additional context such as the mode, frequency, timing, length, style, and/or tone, among other behavioral properties of the communication can also be tracked as part of a behavioral-based security profile. In some embodiments, the user tracking is performed on a pair-wise basis to establish the context each pair of users communicates. The tracking can also identify behavioral groupings of users. For example, a behavioral-based user security profile can track that a select group of VIPs commonly communicate and share sensitive data between themselves each Monday morning and Friday afternoon. As another example, a behavioral-based user security profile can track that certain finance members have frequent contact with a limited number of outside vendors to share financial data, and/or that only certain members of a legal team and product teams commonly communicate. By utilizing a behavioral-based user security profile, communications outside these behavioral norms can be identified as anomalous and warrant additional analysis.

In some embodiments, content analysis module 215 is a behavioral-based analysis module for generating, monitoring, and tracking a content security profile. The tracked content can include documents including cloud-based documents, links to documents, communication channels such as video conference channels, and file sharing locations, among other content sharing related resources. In some embodiments, the tracked behavioral-based content profiles can include tracked context on how a document is used, how a document is accessed, how a document is shared, commonly used words and/or tone used by a confidential or sensitive document, etc. Similar to the application of user analysis module 213 to user behaviors, content analysis module 215 analyzes content to identify behavioral patterns. By utilizing a behavioral-based content security profile, content can be identified as sensitive and at risk for data loss. When sensitive content is shared outside the behavioral norms, the content share request can be identified as anomalous and warrant additional analysis.

In some embodiments, vendor analysis module 217 is a behavioral-based analysis module for generating, monitoring, and tracking a vendor security profile. The tracked vendor data can include which vendors, including outside vendors and their applications, are configured and authorized for use. Additionally, the tracked vendor context can include interaction, relationship, and history data for different vendors including which vendors can share data and with whom. The tracked vendors can include different cloud-based management services, such as human resources, sales, and project management services as well as financial services. For example, behavioral patterns can be tracked to determine that sharing financial documents with a project management service is an anomalous behavior. As another example, behavioral patterns can be tracked to determine that sharing earnings data with one financial service company is common during certain weeks of the fiscal year but that sharing the same data with a different financial service company is an anomalous behavior.

In some embodiments, content share detection module 219 is a processing module for detecting content share requests or instances when a user attempts to share content. For example, content share detection module 219 can detect an indication that a user is attempting to share content, such as when a user attempts to send an outbound email. In various embodiments, content share detection module 219 is configured and/or integrated with one or more cloud services to monitor when content may be shared. For example, using an application programming interface (API), content share detection module 219 can monitor events that indicate that content including sensitive content is about to be shared thereby triggering the analysis of the content share request for security risks. In some embodiments, the content share extends beyond outbound emails and can include cloud services such as file sharing and collaboration platforms, other messaging platforms, and conferencing platforms, among others.

In some embodiments, security risk analysis module 221 is a processing module for detecting security risks associated with content sharing requests. Security risk analysis module 221 utilizes the behavioral-based profiles tracked by user analysis module 213, content analysis module 215, and/or vendor analysis module 217. When a content share request is detected by content share detection module 219, the context of the content share request and various security profiles are used to determine whether the behavior of the content share request indicates an anomaly and a potential security risk. In some embodiments, a large language model (LLM) is used to process the content share request and to predict security risks. For example, an LLM can be used to predict the likelihood of a security risk, such as a security risk score, a severity score of a predicted security risk, and/or a security risk category among other predictions. In various embodiments, the prediction is an AI-driven behavioral-based prediction based on tracked security profiles and expected behavior for the user, content, and/or vendors involved in the content share request. In some embodiments, the security risk analysis module 221 may further also predict a remediation solution such as a security action plan to perform in response to a predicted security risk.

In some embodiments, remediation module 223 is a processing module for resolving identified security risks, such as an outbound email that includes confidential financial information but also inadvertently includes an unintended recipient who should not have access to the financial data. Remediation module 223 can automatically implement and perform security actions on identified security risks and/or allow for the manual initiation of security actions. Example security actions include providing a warning or similar notification, blocking the content share request, and/or auditing the content share request, among other actions. In some embodiments, the warning notification may require confirmation that the warning was received and/or understood before the content share request can be approved. In some embodiments, blocking the content share request may put the request in a quarantined state until the risk is resolved, or the request (such as an outbound email) is released from quarantine. In various embodiments, the security actions can include initiating a training session. For example, a training session can be initiated along with reporting module 225 to provide a user with the appropriate knowledge to address the current security risk and/or future security risks.

In some embodiments, reporting module 225 is a processing module for providing content sharing protection results including security risk detection results related to data loss. For example, using reporting module 225, behavioral analysis performed on a content sharing request can be managed, reviewed, and audited. In some embodiments, reporting module 225 includes a dashboard or similar user interface for reporting and/or reviewing detected security risks and/or remediation actions performed on the detected risks. The dashboard can further allow a user to manually address a detected security risk, such as to release a blocked content sharing request and/or to modify a content sharing request such that it no longer presents a security risk. In some embodiments, reporting module 225 initiates the sending of warnings related to detected security risks, such as by sending a notification that a security risk has been detected and/or requiring confirmation to proceed with a content share request that has an associated detected security risk. Reporting module 225 may further include the ability to initiate and perform a training session. For example, a training session can be initiated to train a user on avoiding future security risks and/or on how to address a current detected security risk. The training session can be an interactive session such as a chat-based session with a large language model (LLM) agent.

In some embodiments, data stores 227 are one or more data stores used for content sharing protection. For example, data stores 227 can be used to store data associated with behavioral-based security profiles and detected security risks. Data stores 227 can also store configuration data such as preferred remediation approaches, tolerance to severity scores, preferences for automatic or manual security actions, and/or configuration data for generating customized audit or reporting content, among other data. In various embodiments, other stored data can include security risk analysis data including security risk logs and/or AI models and related model data. In the example shown, data stores 227 can be utilized by the different modules of content sharing protection service 201. Although shown as integrated with content sharing protection service 201, data stores 227 can include distributed and/or third-party data storage services.

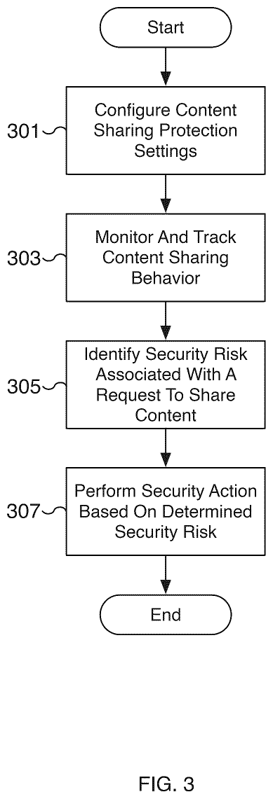

FIG. 3 is a flow chart illustrating an embodiment of a process for protecting against data loss from content sharing. For example, using the process of FIG. 3, a cloud service can be evaluated and monitored for data loss associated with content sharing. In various embodiments, behavioral-based profiles including a user security profile based on historical interactions are tracked. Other profiles such as content and vendor profiles can be tracked as well. When an attempt is made to share content, the content sharing request is evaluated for potential loss of data, including both inadvertent and unauthorized sharing of content. In the event a security risk is identified based on the tracked behavioral-based profiles, a security action is performed. For example, the content sharing request can be blocked or a warning issued to the user such as to confirm that the content sharing is intentional. In some embodiments, the process of FIG. 3 is performed by a content sharing protection service such as content sharing protection service 141 of FIG. 1 and/or content sharing protection service 201 of FIG. 2. In some embodiments, the cloud service associated with the content sharing is cloud service 131 of FIG. 1.

At 301, content sharing protection settings are configured. For example, configuration settings for enabling content sharing protection are configured. In some embodiments, the configuration is performed using a dashboard accessed via a web application, via a command-line interface, via an application programming interface, and/or via a remote client, among other techniques. In some embodiments, the settings include configuring interoperability with desired cloud services, such as configuring authorization and access settings to allow the content sharing protection service to monitor and track email and/or file sharing cloud services. Other settings such as security risk and severity score thresholds can be configured as well. For example, a security risk threshold can be configured to determine the appropriate threshold required for a security risk score to be considered an actionable security risk. In some embodiments, the security actions performed in response to a security risk can be configured to be performed automatically, such as to automatically quarantine an outbound email that is a security risk for data loss. As another example, security training sessions can be configured to require certain users or groups of users to undergo mandatory security training when a security risk is identified. In some embodiments, content sharing protection is configured for only certain types of security risks based on a predicted security risk category. Other content sharing protection settings can be configured as well, including settings for individual users, groups of users, and/or enterprise-wide settings, among others.

At 303, content sharing behavior is monitored and tracked. For example, content sharing behavior associated with a cloud service configured for data loss protection at 301 is monitored and tracked including by tracking user-initiated content sharing. In various embodiments, the context of the monitored behavior is tracked and used to create security profiles including profiles based on users, content, and/or vendors. For example, a user security profile can track the behavior associated with content sharing requests between specific pairs or groups of users. Similarly, a content security profile can track the behavior associated with different content, such as documents, links, conference channels, or other mediums for sharing content. In some embodiments, a vendor security profile tracks the behavior associated with different vendors such as different third-party vendors.

At 305, a security risk associated with a request to share content is identified. For example, an intent by a user to share content, such as sending an outbound email with confidential data, is detected and identified as a content sharing request. In various embodiments, the content sharing request can include the sharing content, the sharing of a link to content (such as a link to a cloud-based document or file sharing website), and/or the sharing of a medium such as a conference channel or website for accessing content, among other forms of content sharing. The identified content sharing request can be identified by monitoring a cloud service using the configured authorization and access settings configured at 301. In various embodiments, the request is identified ahead of the actual content being shared, allowing a security action to be performed on the content sharing request.

At 307, a security action based on determined security risk is performed. For example, a security action such as a warning or similar notification, blocking the content share request, and/or auditing the content share request, among other actions can be performed to remediate the detected security risk. In some embodiments, the warning notification may require confirmation that the warning was received and/or understood before the content share request can be approved. In some embodiments, the content share request is blocked such as by placing the request in a quarantined state until the determined security risk is resolved, or the content share request (such as an outbound email) is released from quarantine. In various embodiments, the security actions can include initiating a training session. For example, a training session can be initiated to provide a user with the appropriate knowledge to address the current security risk and/or future security risks.

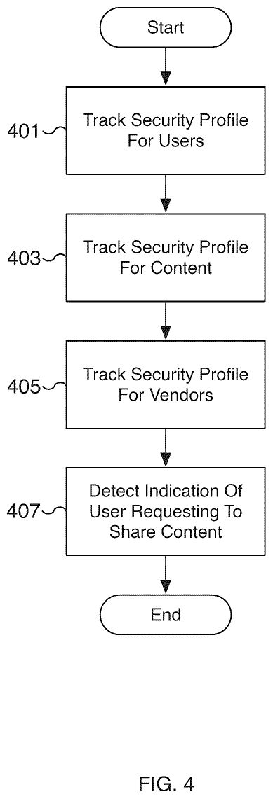

FIG. 4 is a flow chart illustrating an embodiment of a process for monitoring and tracking content sharing behavior. For example, using the process of FIG. 4, content sharing associated with cloud services can be monitored and tracked to build behavioral-based security profiles, including profiles for user, content, and/or vendor behaviors. Additionally, when new content sharing is initiated, such as an attempt to send an outbound email, an indication of a content sharing request is detected. In various embodiments, the detected content sharing request and its associated context trigger an AI-driven behavioral-based analysis to detect security risks using the tracked security profiles. In some embodiments, the process of FIG. 4 is performed at 303 of FIG. 3 by a content sharing protection service such as content sharing protection service 141 of FIG. 1 and/or content sharing protection service 201 of FIG. 2. In some embodiments, the cloud service associated with the content sharing and monitoring for data loss prevention is cloud service 131 of FIG. 1.

At 401, a security profile for users is tracked. For example, a behavioral-based security profile for users is created by tracking user behavior over time including by analyzing historical data. In some embodiments, the tracked data includes which users communicate with one another as well as the context of those communications. For example, pair-wise and group relationships between users can be established. The context for each relationship such as the mode, frequency, timing, length, style, and/or tone, among other behavioral properties of the communication between users can also be tracked and used to build a behavioral-based security profile.

At 403, a security profile for content is tracked. For example, a behavioral-based security profile for content is created by tracking content behavior over time including by analyzing historical data. The tracked content can include documents (including both local and cloud-based documents), links to documents, communication channels such as video conference channels, and file sharing locations, among other content related resources that can be shared. In some embodiments, the tracked data for the security profile includes how particular content is used, accessed, and/or shared. Additionally, the content can be analyzed to determine commonly used words and/or tone for categorizing the security level of content such as whether the content corresponds to a confidential or sensitive document. In some embodiments, users can provide additional labeling data such as specific keywords such as project or product codenames as well as describing the tone of different content for building a behavioral-based security profile for content.

At 405, a security profile for vendors is tracked. For example, a behavioral-based security profile for vendors is created by tracking behavior related to different vendors over time including by analyzing historical data. The tracked vendor data can include tracked vendor context on interactions, relationships, and historical data for particular vendors such as service vendors, among other context data. Service vendors can include cloud-based management services, such as human resources, sales, and project management services as well as financial services. The tracked vendor data used to create a vendor security profile can be used to differentiate between normal and anomalous behavior when interacting with a vendor. In some embodiments, since vendors can be third parties and they may provide very limited or no internal access, the addition of a vendor security profile improves the ability to characterize the context of content sharing behavior when dealing with outside sources. In some embodiments, a third-party vendor can provide expected behavioral data to help generate a vendor-specific security profile. For example, a financial services company can provide vendor specific data to differentiate between normal and anomalous behavior.

At 407, an indication of a user requesting to share content is detected. For example, a user attempt to share content is detected and triggers a content sharing request. The identified content sharing request is an indication that the user is requesting to share content that could include content that should not be shared. The attempted content sharing can be inadvertent, such as a mistyped email recipient address or incorrectly setting permissions on a shared document, or unauthorized, such as theft of corporate secrets. In various embodiments, the content sharing protection service is integrated with each configured cloud service to detect when content sharing is attempted allowing the content sharing request to be analyzed by the content sharing protection service for security risks.

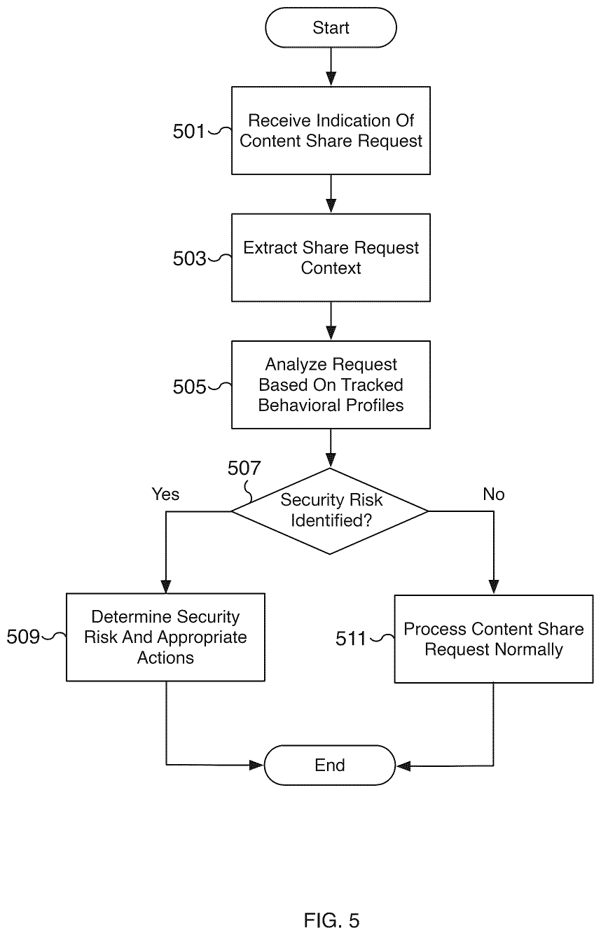

FIG. 5 is a flow chart illustrating an embodiment of a process for identifying a security risk associated with a request to share content. For example, using the process of FIG. 5, an attempt to share content associated with a cloud service is analyzed to determine whether the content share request is a security risk. In the event a security risk is identified, the security risk can be addressed, such as by performing a security action to remediate the identified security risk. In various embodiments, the analysis for detecting a security risk is an AI-driven behavioral-based analysis based on the tracked security profiles and the context of the content share request. In some embodiments, the process of FIG. 5 is performed at 305 of FIG. 3 by a content sharing protection service such as content sharing protection service 141 of FIG. 1 and/or content sharing protection service 201 of FIG. 2. In some embodiments, the cloud service associated with the content sharing request is cloud service 131 of FIG. 1.

At 501, an indication of a content share request is received. For example, a content sharing protection service detects that a user is attempting to share content, triggering an indication of a content share request. In some embodiments, the content sharing protection service integrates with cloud services, monitoring interactions to detect content share requests. When a content share event is detected, the indication of a content share request initiates a security risk analysis to determine whether the attempted sharing of content is a security risk and could result in the potential loss of data.

At 503, the context for the content share request is extracted. For example, the extracted context can include context data related to the users and the content involved in the content share request. In various embodiments, the extracted user context can include the parties and/or users involved, such as the sender and intended recipients, as well as the mode, frequency, timing, length, style, and/or tone, among other behavioral user context properties. Content-based context that is extracted can include how the content is used, accessed, and/or shared. Additionally, the content context that can be extracted can include whether certain keywords or phrases are used and/or the tone used within the content. In some embodiments, extracted vendor context is similarly extracted and can include vendor interactions, relationships, and/or other vendor properties used to identify different behaviors when interacting with the particular vendor. In some embodiments, the extracted context includes different behavioral properties of the content share request for differentiating between normal and anomalous behavior.

At 505, the content share request is analyzed based on tracked behavioral profiles. For example, the context extracted at 503 and tracked behavioral-based security profiles are used to analyze the behavior of the content share request. In some embodiments, the context and behavioral profile data are fed to a large language model (LLM) trained to identify and/or predict whether the content sharing is anomalous behavior associated with a security risk. In various embodiments, the analysis determines a likelihood the content share request is a security risk and can assess one or more different scores such as a security risk score and/or a severity score.

At 507, a determination is made whether a security risk is identified. In the event a security risk is identified, processing proceeds to 509. For example, a security risk can be identified when a predicted security risk score exceeds a security risk threshold used for identifying a security risk associated with the content share request. In the event no security risk is identified, processing proceeds to 511.

At 509, a security risk and appropriate actions are determined. For example, a security risk is identified from the analysis performed at 505 and the appropriate actions, such as a security action, including a potential remediation action step, are performed. In some embodiments, the appropriate action is based on the prediction resolution solution and/or can be based on configured settings. For example, the content share request can be automatically blocked or a warning can be issued that only temporarily blocks the content share request until a user confirmation to proceed is received. In some embodiments, a warning is provided along with training information, such as an interactive training session designed to provide the user with the necessary knowledge on how to resolve the detected security risk. In some embodiments, auditing and/or reporting processes are performed in response to the detected security risk.

At 511, the content share request is processed normally. For example, since no security risk is identified and associated with the content share request, the content in question is allowed to be shared. In some embodiments, the user's workflow proceeds as normal without any interruptions. For example, an outbound email is sent to the intended recipients without any modifications to the included content.

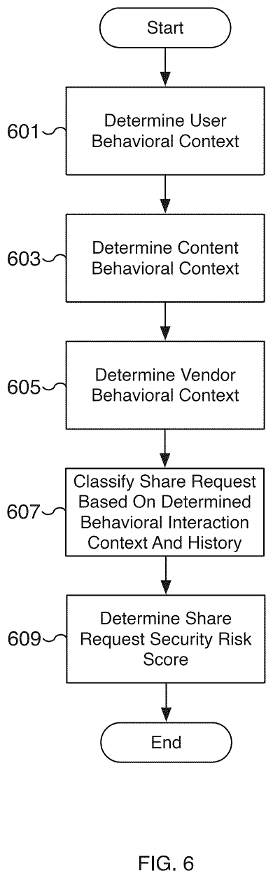

FIG. 6 is a flow chart illustrating an embodiment of a process for identifying a security risk associated with a request to share content based on the behavioral context. For example, using the process of FIG. 6, the user, content, and/or vendor context of a content share request is used to identify a potential security risk by first classifying the content sharing request using an AI-driven prediction model. Additionally, assessment scores such as a security risk and a severity score can be determined for an identified security risk. In some embodiments, the process of FIG. 6 is performed at 305 of FIG. 3 and/or at 503, 505, 507, and/or 509 of FIG. 5 by a content sharing protection service such as content sharing protection service 141 of FIG. 1 and/or content sharing protection service 201 of FIG. 2. In some embodiments, the cloud service associated with the content sharing request is cloud service 131 of FIG. 1.

At 601, user behavioral context is determined. For example, user data related to the users involved in the content share request is extracted to determine the user context of the content share request. In various embodiments, the extracted user context data is used to determine the parties and/or users involved as well as other contextual data such as mode, frequency, timing, length, style, and/or tone of the communication between the users involved in the share request. These extracted contextual data points can be used in subsequent security risk analysis steps at 607 and/or at 609 to determine whether the underlying behavior of the share request is anomalous. For example, a content share request between two users that have no previous relationship, no shared connections, and are in different offices and departments is used as a baseline to evaluate a content share request between them.

At 603, content behavioral context is determined. For example, content data related to the content involved in the content share request is extracted to determine the content context of the content share request. In various embodiments, the extracted content context data is used to determine whether sharing the content in question is anomalous behavior. For example, source code included as an attachment in an outbound email may be anomalous behavior, particularly when the same users typically do not exchange source code. Similarly, including financial and product release documents during a blackout period may be anomalous behavior. In some embodiments, the tone, length, document type, and context behind the sharing of the content is determined. Additionally, the content can be analyzed for specific keywords or phrases, such as confidential labels or product codenames, to determine the nature and level of sensitivity of the content. These extracted contextual data points can be used in subsequent security risk analysis steps at 607 and/or at 609 to determine whether the underlying behavior of the share request is anomalous.

At 605, vendor behavioral context is determined. For example, vendor data related to the content involved in the content share request is extracted to determine the vendor context of the content share request. In various embodiments, the extracted vendor context data is used to determine whether sharing the content in question is anomalous behavior. For example, sharing detailed financial statements from a financial services vendor may be anomalous behavior, particularly when access to the detailed financial data is highly restricted. However, sharing source code from a source code management service may be normal behavior for a particular software project when an organization and/or vendor has designated the project as an open source project. In some embodiments, interactions between different vendors and their relationships are similarly used to determine anomalous behavior. For example, communication between two vendors that are intended to be walled off from one another, such as to prevent conflicts, can be anomalous behavior. These extracted contextual data points can be used in subsequent security risk analysis steps at 607 and/or at 609 to determine whether the underlying behavior of the share request is anomalous.

At 607, the content share request is classified based on the determined behavioral interaction context and history. For example, based on the different dimensions of behavioral context determined at 601, 603, and/or 605, the content share request can be classified into a particular type of content sharing request. In some embodiments, the classification is performed using a machine learning model such as a trained model for classification and/or a large language model. In various embodiments, the classification prediction can also utilize tracked behavioral profiles such as a user, content, and/or vendor security profile, which can correspond to tracked historical behavioral data. The tracked behavioral profiles can provide additional context for different behaviors associated with content sharing and can be applied to the current content sharing request. In some embodiments, the different classes used for prediction are based on different forms of security risks associated with data loss.

At 609, the security risk scores for the content share request are determined. For example, one or more security risk prediction scores can be determined using an AI-driven process such as using a trained machine learning model including a large language model. In some embodiments, the scores can include a security risk score, which can correspond to the likelihood the security risk class predicted at 607 is a security risk. In some embodiments, the predicted scores can include a severity score that corresponds to the severity of a predicted security risk posed by the content share request. Other scores can be predicted as well and can be used for determining whether a security risk exists and/or the appropriate resolution solutions in the event a risk is identified.

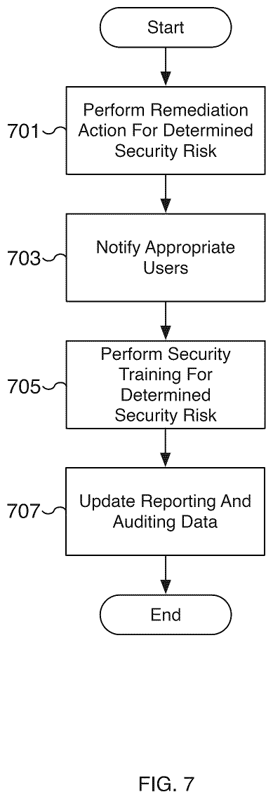

FIG. 7 is a flow chart illustrating an embodiment of a process for remediating an identified security risk associated with a request to share content. For example, using the process of FIG. 7, one or more security actions are performed to minimize the potential damage associated with an identified data loss security risk. The performed security actions can include automatically initiated security actions, manually triggered security actions, and follow-up security actions such as follow-up security training for users. In some embodiments, the identified security risk and related context are tracked to allow for reporting and auditing of the content sharing request and associated identified security risk. In some embodiments, the process of FIG. 7 is performed at 305 and/or 307 of FIG. 3 and/or at 509 of FIG. 5 by a content sharing protection service such as content sharing protection service 141 of FIG. 1 and/or content sharing protection service 201 of FIG. 2. In some embodiments, the cloud service associated with the content sharing request is cloud service 131 of FIG. 1.

At 701, a remediation action is performed for the determined security risk. For example, a remediation action is determined and can be automatically performed. In some embodiments, the remediation action includes multiple steps that can be performed in series and/or in parallel. Example remediation actions can include blocking the content sharing request, providing a warning related to the content sharing request, and/or auditing the content sharing request. In some embodiments, multiple actions are performed such as temporarily blocking the request until a warning message can be acknowledged. In some embodiments, the content sharing request is modified such that the content in question is removed from the request, such as outbound email. In various embodiments, the remediation action can be determined and performed automatically.

At 703, the appropriate users are notified. For example, the appropriate users that can be notified can include the user attempting to share the content, one or more security administrators responsible for data loss prevention, and/or one or more owners of the content associated with the content share request, among other users. In some embodiments, the set of users that receive notifications is configured, such as by a security administrator. In various embodiments, the notified users can include automated user accounts such as a reporting or auditing user agent. In some embodiments, user notifications are provided via a dashboard such as via a web application management platform. Other mediums for notification can be appropriate as well, such as via email, a notification window, or within an application used for sharing the content.

At 705, security training is performed for the determined security risk. For example, a training session can be initiated to provide training material on the determined security risk. The training session can be an interactive session such as via a chat agent or video chatbot. In some embodiments, the interactive training session utilizes a large language model, such as for preparing responses to user questions. The training session can be used to provide the user with the necessary knowledge on how to resolve the current security risk and/or how to avoid future security risks associated with data loss prevention. Training session data can be tracked to improve future training sessions and/or to track user security training progress.

At 707, reporting and auditing data are updated. For example, analysis data including extracted context data is updated and can be utilized for reporting and auditing. In some embodiments, the reporting data can include automatically generated reporting data results, which can be provided to users and/or administrators. Similarly, the reporting data can be provided via a dashboard such as via a data loss prevention management dashboard. As another example, the auditing data including the ability to perform an audit on a content sharing request can be provided via a similar dashboard allowing security administrators to track and audit any detected security risk. In various embodiments, the reporting and auditing data can be sanitized to exclude sensitive data such as confidential data.

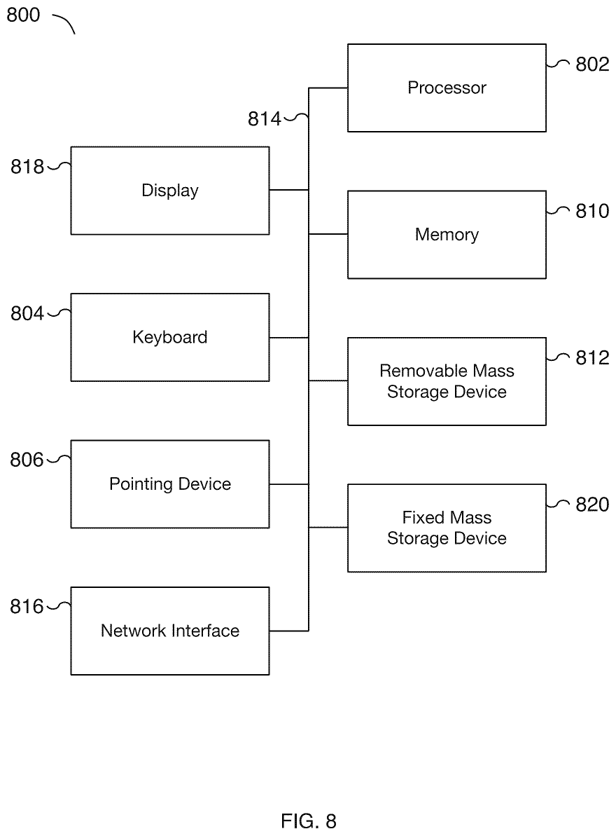

FIG. 8 is a functional diagram illustrating a programmed computer system for providing outbound content sharing protection. As will be apparent, other computer system architectures and configurations can be utilized for providing outbound content sharing protection. Examples of computer system 800 include clients 101, 103, and 105 of FIG. 1, one or more computers of cloud service 131 of FIG. 1, one or more computers of content sharing protection service 141 of FIG. 1, and/or one or more computers of content sharing protection service 201 of FIG. 2. Computer system 800, which includes various subsystems as described below, includes at least one microprocessor subsystem (also referred to as a processor or a central processing unit (CPU)) 802. For example, processor 802 can be implemented by a single-chip processor or by multiple processors. In some embodiments, processor 802 is a general purpose digital processor that controls the operation of the computer system 800. Using instructions retrieved from memory 810, the processor 802 controls the reception and manipulation of input data, and the output and display of data on output devices (e.g., display 818). In various embodiments, one or more instances of computer system 800 can be used to implement at least portions of the processes of FIGS. 3-7.

Processor 802 is coupled bi-directionally with memory 810, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 802. Also as is well known in the art, primary storage typically includes basic operating instructions, program code, data and objects used by the processor 802 to perform its functions (e.g., programmed instructions). For example, memory 810 can include any suitable computer-readable storage media, described below, depending on whether, for example, data access needs to be bi-directional or unidirectional. For example, processor 802 can also directly and very rapidly retrieve and store frequently needed data in a cache memory (not shown).

A removable mass storage device 812 provides additional data storage capacity for the computer system 800, and is coupled either bi-directionally (read/write) or unidirectionally (read only) to processor 802. For example, storage 812 can also include computer-readable media such as magnetic tape, flash memory, PC-CARDS, portable mass storage devices, holographic storage devices, and other storage devices. A fixed mass storage 820 can also, for example, provide additional data storage capacity. The most common example of mass storage 820 is a hard disk drive. Mass storages 812, 820 generally store additional programming instructions, data, and the like that typically are not in active use by the processor 802. It will be appreciated that the information retained within mass storages 812 and 820 can be incorporated, if needed, in standard fashion as part of memory 810 (e.g., RAM) as virtual memory.

In addition to providing processor 802 access to storage subsystems, bus 814 can also be used to provide access to other subsystems and devices. As shown, these can include a display monitor 818, a network interface 816, a keyboard 804, and a pointing device 806, as well as an auxiliary input/output device interface, a sound card, speakers, and other subsystems as needed. For example, the pointing device 806 can be a mouse, stylus, track ball, or tablet, and is useful for interacting with a graphical user interface.

The network interface 816 allows processor 802 to be coupled to another computer, computer network, or telecommunications network using a network connection as shown. For example, through the network interface 816, the processor 802 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 802 can be used to connect the computer system 800 to an external network and transfer data according to standard protocols. For example, various process embodiments disclosed herein can be executed on processor 802, or can be performed across a network such as the Internet, intranet networks, or local area networks, in conjunction with a remote processor that shares a portion of the processing. Additional mass storage devices (not shown) can also be connected to processor 802 through network interface 816.

An auxiliary I/O device interface (not shown) can be used in conjunction with computer system 800. The auxiliary I/O device interface can include general and customized interfaces that allow the processor 802 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 8 is but an example of a computer system suitable for use with the various embodiments disclosed herein. Other computer systems suitable for such use can include additional or fewer subsystems. In addition, bus 814 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
tracking a security profile for a user based at least in part on content interaction history of the user;
receiving an indication that the user is requesting to share content;
analyzing context of the requested sharing based at least in part on the security profile to determine a security risk associated with the requested sharing; and
performing a security action based on the determined security risk.

2. The method of claim 1, wherein the content is associated with a document, a link to a cloud-based document, a link to a file sharing website, or a reference to a conference channel.

3. The method of claim 1, wherein the content is associated with an attachment or an embedded link of an outbound email.

4. The method of claim 1, wherein the security action performed based on the determined security risk includes blocking the requested sharing, generating a warning of the requested sharing, or auditing the requested sharing.

5. The method of claim 4, wherein blocking the requested sharing includes placing an email in a quarantine state.

6. The method of claim 1, wherein the security action performed based on the determined security risk includes initiating a training session based on the determined security risk.

7. The method of claim 6, wherein the training session is an interactive session, and wherein the interaction session includes one or more large language model generated responses to one or more user provided questions.

8. The method of claim 1, wherein tracking the security profile for the user based at least in part on the content interaction history of the user includes determining a mode, a frequency, a timing, a length, a style, or a tone for tracked content included in the content interaction history.

9. The method of claim 1, further comprising tracking an another security profile based on content properties, wherein at least a portion of the content properties is associated with how a tracked content is used, accessed, or shared.

10. The method of claim 1, wherein analyzing the context of the requested sharing includes determining a tone or identifying a keyword for the content.

11. A system, comprising:
one or more processors configured to:
track a security profile for a user based at least in part on content interaction history of the user;
receive an indication that the user is requesting to share content;
analyze context of the requested sharing based at least in part on the security profile to determine a security risk associated with the requested sharing; and
perform a security action based on the determined security risk; and
a memory coupled to the one or more processors, wherein the memory is configured to provide the one or more processors with instructions.

12. The system of claim 11, wherein the content is associated with a document, a link to a cloud-based document, a link to a file sharing website, or a reference to a conference channel.

13. The system of claim 11, wherein the content is associated with an attachment or an embedded link of an outbound email.

14. The system of claim 11, wherein the security action performed based on the determined security risk includes blocking the requested sharing, generating a warning of the requested sharing, or auditing the requested sharing.

15. The system of claim 14, wherein blocking the requested sharing includes placing an email in a quarantine state.

16. The system of claim 11, wherein the security action performed based on the determined security risk includes initiating a training session based on the determined security risk.

17. The system of claim 16, wherein the training session is an interactive session, and wherein the interaction session includes one or more large language model generated responses to one or more user provided questions.

18. The system of claim 11, wherein tracking the security profile for the user based at least in part on the content interaction history of the user includes determining a mode, a frequency, a timing, a length, a style, or a tone for tracked content included in the content interaction history.

19. The system of claim 11, wherein analyzing the context of the requested sharing includes determining a tone or identifying a keyword for the content.

20. A computer program product, the computer program product being embodied in a non-transitory computer readable storage medium and comprising computer instructions for:
tracking a security profile for a user based at least in part on content interaction history of the user;
receiving an indication that the user is requesting to share content;
analyzing context of the requested sharing based at least in part on the security profile to determine a security risk associated with the requested sharing; and
performing a security action based on the determined security risk.
